(19) United States
(12) Patent Application Publication
(10) Pub. No.: US 2023/0407194 A1
(43) Pub. Date: Dec. 21, 2023

(54) INTEGRATED HYDRO-DEMETALLIZATION (HDM) UNIT

(71) Applicant: SHELL OIL COMPANY, Houston, TX (US)

(72) Inventors: John Joseph BARIC, Amsterdam (NL); Coen Bernhard HODES, Amsterdam (NL)

(21) Appl. No.: 18/248,255

(22) PCT Filed: Nov. 11, 2021
(86) PCT No.: PCT/EP2021/081352

§ 371 Date: Apr. 7, 2023

(30) Foreign Application Priority Data
Nov. 12, 2020 (EP) 20207250.0

(51) Int. Cl. C10G 65/12

(52) U.S. Cl. CPC C10G 65/12; C10G 2300/70; C10G 2300/42; C10G 2300/4012; C10G 2300/4006; C10G 2300/4018

(57) ABSTRACT

The present invention provides a process for hydro-demetallizing of residual hydro-carbonaceous feedstock. The process includes passing the feedstock to a vertically-disposed reaction zone to produce an effluent which is passed to at least one fixed bed reactor for further processing. The reaction zone includes at least one moving bed reactor, having at least one catalyst bed of hydro-demetallization catalyst configured for catalyst addition and removal. The hydrodemetallization catalyst is subjected to in-line fresh catalyst deairing, pressurizing, and hydrocarbon soaking via a catalyst sluicing system and sulphidic activation before entering the moving bed reactor at a top portion of the moving bed reactor. The hydrodemetallization catalyst is added to the moving bed reactor through gravity and any spent hydrodemetallization catalyst is removed from a bottom portion of the moving bed reactor. The removed spent hydrodemetallization catalyst is subjected to in-line spent catalyst hydrocarbon removal, depressurizing, inerting, and airing.

### FIELD OF INVENTION

The present invention relates to a process for the conversion of hydro-carbonaceous feedstocks. More specifically, the present invention relates to a process for catalytic hydro-demetallizing of residual hydro-carbonaceous feedstock in an integrated hydro-demetallization (HDM) unit comprised of at least one moving bed reactor and at least one fixed bed reactor.

### BACKGROUND OF THE INVENTION

Hydro-carbonaceous feedstocks, for instance heavy oils or residual oils (e.g., bottom of crude barrel feedstocks) as obtained in the distillation of crude oils, often contain quantitative amounts of metal compounds, in particular vanadium and nickel compounds, although iron, zinc, copper, sodium, or calcium compounds may also be present. Depending on the source of the crude oil collected during processing, the total concentration of metal compounds may range up to 1,000 part per million by weight (“ppmw”), occasionally even more. In view of new standards and preparations for the worldwide energy transition, for instance IMO2020, as well as in general increased utilization of the bottom-of-the-barrel into more valuable (e.g. non fuels) products, much research and development is now directed towards methods of producing sweetened (i.e. low-sulfur) and reduced metal feedstocks that may be further passed to refinery conversion units for upgrading into distillates, chemical feedstocks and base oils.

If such residual oils are applied as feed for a particular process, such as catalytic cracking, catalytic hydrotreating, catalytic hydro-conversion, or catalytic hydrocracking processes, a large part of the metals from the residual oils will be deposited on the catalyst particles. As a result of the increasing concentration of metals on the active sites of the catalyst particles, rapid deactivation of the catalyst may occur. To avoid such premature deactivation of the catalyst, so as to obtain full use of the catalyst, metal compounds should be removed, at least partly, from the feed before contact with the catalyst occurs. It is well known in the art that removal of metals and metal compounds from a hydro-carbonaceous feedstock can be achieved by contacting the feedstock at elevated temperatures and pressures in the presence of hydrogen with a suitable de-metallization catalyst. It is also well known that when catalytic activity is no longer satisfactory, the spent de-metallization catalyst is often replaced with fresh catalyst or the spent catalyst is regenerated to produced regenerated de-metallization catalyst. The regenerated de-metallization catalyst may be recycled for continual use to remove metals from the residual oils before additional processing takes place.

Furthermore, the configuration of the reactors used to process such difficult feedstocks often affects the cycle length of the overall unit. It is well-known that during the hydro-processing of hydro-carbonaceous feedstocks, catalyst aging and deactivation may be counterbalanced by continuously increasing reaction temperatures. Temperatures may be increased to the point that when maximum reactor temperatures are reached, process operations shut down, sometimes doing so prematurely. Therefore, in order to attain the highest product yields, an optimum reactor configuration must be established and put in place in order to maximize unit cycle length, where the longer the cycle length, the longer the life of the catalyst before regeneration or otherwise disposal is needed.

U.S. Pat. No. 4,551,230 describes a method for removing metals from a hydrocarbon containing feed stream and a catalyst under suitable demetallization conditions with hydrogen and a catalyst composition comprising (a) an alumina-containing support and (b) nickel arsenide, NiAsₓ, wherein x ranges from about 0.33 to about 2.0. US20050006283 describes a method for extending the life of a catalyst as used in hydro-processing of a hydrocarbon feed stream. In particular, the method describes ex-situ pre-sulfiding of a hydrocarbon conversion catalyst for use in a moving bed reactor.

US20110094938 describes a process of converting a hydrocarbon feedstock, for example a petroleum residue, to lighter products by integrating both moving bed and ebullating bed technologies in an effort to maximize feed conversion.

Various problems, such as limitations to feedstock metal content, uneconomical short catalyst cycle length, and lengthy catalyst change-out stops, still exist during demetallization of hydro-carbonaceous feedstock. Thus, despite the aforementioned and other measures, continual advancements for efficient hydro-demetallizing of hydro-carbonaceous feedstocks are needed in view of heavier feedstock processing and ever-more stringent product specifications.

Thus, the object of the present invention includes providing an inventive integrated process that encourages enhanced feed demetallization and demetallization catalyst usage, preparation and regeneration methods to provide more desirable alternatives to conventional demetallization techniques, as well as, promoting longer reaction cycle lengths when processing hydro-carbonaceous feedstocks containing high metal content.

### DESCRIPTION OF THE DRAWINGS

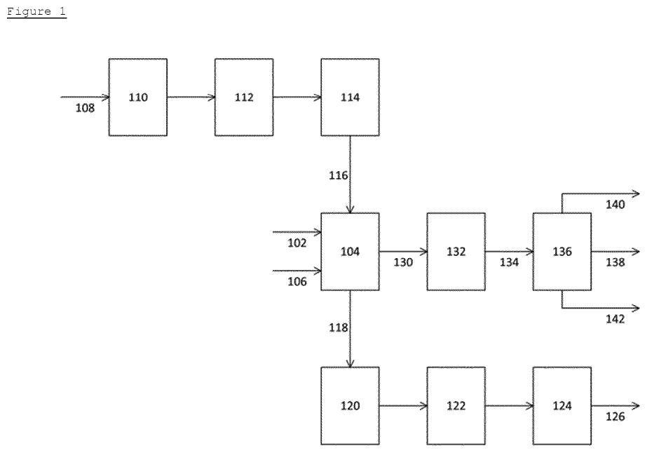

Certain exemplary embodiments are described in the following detailed description and in reference to the drawings, in which FIG. 1 depicts a process according to the present invention.

### SUMMARY OF THE INVENTION

It has now advantageously been found that the above described problems and shortcomings of conventional techniques are overcome by the present invention. Accordingly, the present invention relates to a process for hydro-demetallizing of residual hydro-carbonaceous feedstock. The process includes passing the feedstock to a vertically disposed reaction zone comprising at least one moving bed reactor to produce an effluent which is thereafter passed to at least one fixed bed reactor for further processing. The at least one moving bed reactor of the present invention comprises at least one catalyst bed of hydro-demetallization catalyst and is configured for catalyst addition and removal. The hydrodemetallization catalyst, before entering the moving bed reactor, is subjected to in-line fresh catalyst deairing, pressurizing, and hydrocarbon soaking via a catalyst sluicing system. Additionally, the catalyst is further subjected to sulphidic activation before entering the moving bed reactor at a top portion of the moving bed reactor. In the embodiments, it is preferred that the hydrodemetallization catalyst is added to the moving bed reactor through gravity. Any spent hydrodemetallization catalyst is removed from a bottom portion of the moving bed reactor during processing of the feedstock and is thereafter subjected to in-line spent catalyst hydrocarbon removal, depressurizing, inerting, and airing. In preferred embodiments, the reactor internals located within the reaction zone provide balance and controlled catalyst movement during catalyst addition and removal from the moving bed reactor.

Other advantages and features of embodiments of the present invention will become apparent from the following detailed description. It should be understood, however, that the detailed description, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The demetallization process of this invention is achieved by contacting a residual hydro-carbonaceous feedstock with a hydrodemetallization catalyst composition, and in some embodiments the feedstock is mixed with gas, in one or more vertically disposed moving bed reactors of an HDM unit. The processing of the feed within the moving bed reactor(s) is achieved under suitable catalytic demetallization conditions, i.e. elevated temperature and pressure, as the feedstock passes through the moving bed reactor(s). While hydro-demetallization of the feedstock is preferably carried out in moving bed reactors in the present embodiments, it may also be carried out in moving bed or so-called bunker flow reactors in addition to the moving bed reactors in other embodiments. In the present embodiments, the hydrodemetallization catalyst composition is subjected to pre-treatment, as will be further described, before entering the moving bed reactor. The moving bed reactor of the embodiments comprises reactor internals that provide balance and control for the hydrodemetallization catalyst and spent hydrodemetallization catalyst upon entering and exiting the reactor, respectively. The spent hydrodemetallization catalyst is subjected to further processing for regeneration or safe disposal purposes.

An effluent is produced by and passes from the moving bed reactor(s) into at least one vertically disposed fixed bed reactor for further processing, mainly to reduce other contaminants. In particular, the inventive combination of providing moving bed reactors upstream of fixed bed reactors acts to further reduce sulfur and Conradson carbon residue (CCR), among other contaminants. The inventive combination enables continuous catalyst replenishment within the moving bed reactor, so as to maintain consistent catalyst activity level with no deactivation over time since bulk metal removal is intensified. Additionally, the inventive combination decouples hydro-demetallization from the functionalities of the fixed bed reactor so as to allow for the installation of higher amounts of catalyst. Advantageously, this unique process enables improved cycle lengths, for instance, a cycle of over two years between change-outs.

The residual hydro-carbonaceous feedstocks to be used in accordance with the present invention include suitable residual hydrocarbon oils, such as those obtained in the distillation of crude oils at atmospheric or reduced pressure. Preferably, the feedstocks can include at least one of a vacuum gas oil (VGO) corresponding to a cut heavier than 370° C. and less than 560° C., a de-asphalted oil (DAO) corresponding to a 370+° C. cut after partial removal of asphaltenes through a liquid-liquid extraction process, a long or atmospheric residue (LR or AR) corresponding to a 370+° C. cut, and a short or vacuum residue (SR or VR) corresponding to a 520+° C. cut. In accordance with the preferred embodiments, the feedstock is in premixed liquid form that is heated and mixed with a gas, such as hydrogen, before entering the reactor.

Quantitative amounts of metal compounds, in particular vanadium (Va) and nickel (Ni) compounds are often present in the feedstock, although also iron, zinc and copper compounds, among other metals may be present in identifiable amounts. In the present embodiments, the feedstock contains a concentration of Va and Ni ranging from 25 to 500 weight part per million (ppm(wt)).

Suitable hydrodemetallization catalysts used in accordance with the present invention consist of amorphous supports such as alumina, silica or silica-alumina, on which one or more Group VIB metals or metal compounds may be deposited. Preferably, the Group VIB metals include molybdenum (Mo) or tungsten (W). In other embodiments, and in addition to the Group VIB metals, the catalyst may further include at least one Group II metal selected from nickel (Ni) and cobalt (Co). Such hydrodemetallization catalysts are commercially available from many catalyst suppliers. Examples of particularly suitable catalysts are CoMo/Al₂O₃, CoMoP/Al₂O₃ and NiMo/Al₂O₃ and NiMoP/Al₂O₃ catalysts.

The hydrodemetallization catalysts used in the present invention has been developed to create maximum unhindered flow with gravity as the only driving force to move the catalyst through the moving beds, and therefore is spherical in form. The hydrodemetallization catalyst has been further developed to facilitate low attrition, breakage or dust formation, where such acts are often produced during grinding of the moving catalyst when in contact with reactor internals. Accordingly, the hydrodemetallization catalyst of choice is comprised of hard material(s) that can withstand large shear and crushing forces.

The hydrodemetallization catalyst may be specified with a size in a range from 1.2 to 3.5 millimeters (mm) and a tight size distribution in order to allow vapor and liquid flow to pass separation equipment while remaining within the catalyst flow path. Accordingly, the hydrodemetallization catalyst may have a pore diameter distribution between 100 Å (Ångström) to 0.2 μm (micrometer) with a medium pore diameter between 20 and 40 Δ (Ångström), a surface area of at least 80 m²/g, preferably, in a range from 100 m²/g to 150 m²/g, a crushing strength of minimum 3 daN, and a shear test result of less than 2% attrition at high applied force and less than 5% at very high applied force.

Before entering the moving bed reactor located within the reaction zone of the HDM unit, the embodiments of the present invention may subject the hydrodemetallization catalyst composition to pre-treatment. In particular, the hydrodemetallization catalyst is subjected to in-line fresh catalyst deairing to avoid air ingress, pressurizing to reactor conditions, and hydrocarbon soaking for optimal trickle bed operation via a catalyst sluicing system before entering the moving bed reactor(s). In other embodiments, a catalyst sluice system can suitably feed to and receive from multiple moving bed reactor(s) to enable catalyst addition and removal from the reactor(s).

The inventive process is carried out in at least one individual moving bed reactor within an individual vertically disposed reactor zone, with preferably co-current flow to the catalyst, in other terms trickle flow operation. The choice of feedstock utilized may result in considerable metal laydown on the hydrodemetallization catalyst, which in turn results in a very swift deterioration/deactivation of the hydrodemetallization catalyst. This may require quicker replacement of the hydrodemetallization catalyst when compared with other known techniques for processing feeds of a lower metal contents. Hence, one of the reasons that the moving bed reactor is the preferable choice where hydro-demetallization catalyst flows downward through the reactor by gravitational forces. Fresh catalyst enters at the top of the movable bed reactor, while deactivated (i.e., spent) catalyst leaves the reactor at a bottom portion. Such movement of the catalyst in the moving bed reactor allows for continuous addition and removal as needed to maintain the appropriate level of activity. The hydrodemetallization catalyst volume in the moving bed reactors may be regularly refreshed (for instance every three weeks or two months) whilst high activity conversion catalyst in the fixed bed reactors can be maximised, and whereas in conventional processes the hydrodemetallization catalyst may not be replaced within a year time or more.

Moving bed reactors, whether it be ebullating beds, fluidized beds, or other known moving bed apparatus, all include large vulnerabilities when applied to various flow regimes, e.g., vapor, liquid, or solid. Such vulnerabilities may include stagnant catalyst or process flow operations, thus, causing poor functioning, uncontrolled reactions, and fouling and coking within the reactor. In accordance with the embodiments, the reactor internals of the moving bed reactor are configured to provide balance and controlled catalyst movement during catalyst addition and removal from the reactor.

Furthermore, in accordance with the embodiments, the reactor internals of the moving bed reactor are configured to avoid dead zones during catalyst flow as well as process flows. Proper fluid flow and quenching may be required to make full use of the hydrodemetallization catalyst's particular properties. Thus, each moveable bed reactor is equipped with internals that optimize the distribution of fluid throughout the reactor during processing. Specifically, the reactor internals of the present invention are configured to facilitate a vapor-liquid mixture flow distribution with less than 5% radial flow differences. Overall, the reactor internals, as used in the present embodiments, provide for stable catalyst and handling control during upflow and/or downflow applications when processing sensitive vapor/liquid flows, thus, achieving plug flow and avoid maldistribution.

The hydrodemetallization of the feedstock within the moving bed reactor can suitably be carried out at a hydrogen partial pressure of 20-300 bara, preferably 60-230 bara, a temperature of 300-470° C., preferably 300-440° C., and more preferably 300-425° C. and a space velocity of hr⁻¹, preferably 0.2 to 7 hr⁻¹. Thus, the moving reactor is also equipped with internals to ensure an optimal flow and temperature control during processing. The hydrodemetallization process in accordance with the present embodiments may be carried out with a quantity of hydrogen between 200 and 1,500 normal cubic meters per cubic meter of liquid feedstock, where it is most advantageous to mix at least a part of the hydrogen with at least a part of the feedstock in order to avoid in-line hydrothermal demetallization and fouling.

When the aforementioned feedstocks are processed during hydrodemetallization processes, metals, coke, and other contaminants will be deposited on the catalyst to produce spent catalyst. As described by conventional techniques, the spent catalyst can be removed from the moving bed reactor at a bottom portion of the reactor. In accordance with the present invention, the spent hydrodemetallization catalyst is subjected to in-line hydrocarbon removal, depressurizing to remove hazardous hydrocarbon and for instance hydrogen bisulphide vapors, and inert flushing to provide safe and efficient discharge. Thereafter, the hydrodemetallization catalyst is ready for ex-situ oxygenation to facilitate metal reclamation, ready for final disposal or reuse.

The effluent produced by the moving bed reactors flows into the fixed bed reactors for further processing, including the removal of other contaminants that remain. The reactor effluent that emerges from the fixed bed reactors is subjected to separation techniques to generate an upgraded or final product. The fixed bed reactors may consist of primarily hydrodesulphurization, hydride-Conradson carbon residue, or hydrocracking into distillates with suitable properties for Base Oils production, Chemical Feedstocks, and/or Transportation Fuels.

FIG. 1 depicts the process according to the present invention. In FIG. 1, a hydro-carbonaceous feedstock is passed via line 102 into at least one moving bed reactor 104 where hydrogen-rich gas via line 106 and possibly recycled hydrogen-rich gas, may also feed into the reactor 104 to maintain and/or to elevate pressure levels. Fresh hydrodemetallization catalyst via line 108 flows into a fresh catalyst hopper 110, preferably at atmospheric pressure. In some embodiments, an inert gas such as nitrogen may be injected into the hopper 110 for inerting. The hopper feeds the catalyst particles into a fresh catalyst conditioning vessel 112. In some embodiments, transport oil is injected to soak the catalyst as well as to enable pressurization with H₂-rich gas. Subsequently, the catalyst particles are fed into at least one fresh catalyst sluice vessel 114. Within the sluice vessel 114, pressurization of the catalyst may occur before passage into the moving bed reactor 104. In particular, the hydrodemetallization catalyst is subjected to in-line fresh catalyst deairing, pressurizing, and hydrocarbon soaking for optimal trickle bed operation via the sluice vessel 114. In preferred embodiments, the hydrodemetallization catalyst is further subjected to hydraulic slurry transport via line 116 to the top portion of reactor 104 and by exposure to reactor conditions slow sulfuric activation treatment for high activity catalyst operation. The treated hydrodemetallization catalyst, thereafter, flows into the moving bed reactor 104 by gravity via a mechanism, such as a catalyst holder and chute pipe system, located in a top portion of the reactor 104. The spent catalyst via line 118 is removed, i.e., withdrawn, from the moving bed reactor 104 into a spent catalyst sluice vessel 120, which depressurizes and transfers the catalyst particles into a spent catalyst conditioning vessel 122. In particular, the spent catalyst is de-oiled, in some embodiments stripped with H₂ rich gas, depressurized, and in some embodiments stripped with nitrogen. The conditioned spent catalyst feeds into a discharge vessel 124 where a final spent catalyst is stripped with nitrogen prior to discharge via line 126. In some embodiments spent catalyst from spent catalyst conditioning vessel 122 or from spent catalyst sluice vessel 120 feeds into fresh catalyst sluice vessel 114 or fresh catalyst conditioning vessel 112 for catalyst recycle.

The hydro-demetallization process according to the present invention is performed, in the presence of hydrogen, under the normal conditions known to the person skilled in the art. Preferably, the hydrogen partial pressure of 20-300 bara, preferably 60-230 bara, a temperature of 300-470° C., preferably 300-440° C., and more preferably 300-425° C. and a space velocity of 0.1-10 hr⁻¹, preferably 0.2 to 7 hr⁻¹. During the hydro-demetallization process metal content of the feedstock is removed via catalytic conversion using the hydrodemetallization catalyst specifically provided for demetallization activity to produce a reactor effluent via line 130.

With the majority of metals removed, the effluent flows into at least one fixed bed reactor 132 for further metal removal and for hydrotreating or hydrocracking, for example, for sulfur, nitrogen, CCR, among other, contaminant removal, or to meet final product specifications. Processing in the fixed bed reactors 132 occurs under normal conditions known to those skilled in the art to produce a reactor effluent via line 134. As would be further known to one skilled in the art, the reactor effluent is often subjected to various separation techniques within a separation/stripper unit 136. As it is not within the scope of the present embodiments, the separation/stripper unit 136 will not be further described in detailed.

A hydro-demetallized product 142 may be separated within unit 136, and thereafter subjected to further conditioning where it is placed in intermediate storage or further treated during subsequent refinery steps. Other products such as process gas via line 140, and (light) distillate products via line 138 may also exit unit 136 to be transported to transportation carriers, pipelines, storage vessels, refineries, other processing zones, or a combination thereof.

It has been surprisingly found that the inventive process for hydro-demetallizing of residual hydro-carbonaceous feedstock reduces, and possibly eliminates, limitations as typically presented by feedstocks containing an appreciable metal content. For example, the use of at least one moving bed reactor, configured for catalyst addition/removal and comprising at least one catalyst bed of hydro-demetallization catalyst, provides for example metal content removal from residual hydro-carbonaceous feedstocks. The reactor internals used in the inventive process provide balance and controlled catalyst movement during catalyst addition and removal from the moving bed reactor.

Unlike conventional processes, the present embodiments subject the hydrodemetallization catalyst to in-line fresh catalyst deairing, pressurizing, and hydrocarbon soaking via a catalyst sluicing system before entering the moving bed reactor. Another advantage of the present embodiments is that the hydrodemetallization catalyst is further subjected to sulphidic activation before entering the moving bed reactor.

Moreover, the inventive process extends the catalyst cycle length and reduces the number of catalyst change-out stops by effectively decoupling bulk hydro-demetallization from the hydro-desulfurization and CCR removal. Specifically, the inventive process' key advantage includes the application of moving bed reactors located upstream of fixed bed reactors which effectively decouples demetallization functions from the CCR and desulfurization functions, thereby enabling much longer cycle lengths in the fixed bed reactors than would be the case with comparable fixed bed technologies when used alone. Since the moving bed reactors target bulk metals removal, the inventive process enables an optimized fixed bed reactor catalyst scheme, thus, achieving exceptionally long catalyst cycles.

It is to be understood that the techniques, as described herein, are not intended to be limited to the particular embodiments as disclosed. Indeed, the present embodiments include all alternatives, modifications, and equivalents falling within the scope of the present techniques.

1. A process for hydro-demetallizing of residual hydro-carbonaceous feedstock, the process comprising:
passing the feedstock to a vertically-disposed reaction zone comprising at least one moving bed reactor to produce an effluent, wherein the at least one moving bed reactor comprises at least one catalyst bed of hydro-demetallization catalyst and is configured for catalyst addition and removal;
subjecting the hydrodemetallization catalyst to in-line fresh catalyst deairing, pressurizing, and hydrocarbon soaking via a catalyst sluicing system before entering the moving bed reactor;
further subjecting the hydrodemetallization catalyst to sulphidic activation before entering the moving bed reactor at a top portion of the moving bed reactor, wherein the hydrodemetallization catalyst is added to the moving bed reactor through gravity;
removing any spent hydrodemetallization catalyst from a bottom portion of the moving bed reactor during processing of the feedstock; and
subjecting the removed spent hydrodemetallization catalyst to in-line spent catalyst hydrocarbon removal, depressurizing, inerting, and airing;
passing the effluent to at least one fixed bed reactor for further processing; and
wherein reactor internals located within the reaction zone provide balance and controlled catalyst movement during catalyst addition and removal from the moving bed reactor.

2. The process of claim 1, wherein at least one catalyst bed comprises a downflow, catalyst bed with co-current flow, facilitating trickle flow bed operation.

3. The process of claim 1, wherein the reactor internals are configured to avoid dead zones during the catalyst addition and removal from the moving bed reactor.

4. The process of claim 3, wherein the reactor internals are configured to facilitate a vapor-liquid mixture flow distribution with less than 5% radial flow differences.

5. The process of claim 1, wherein the hydrodemetallization catalyst is a spherical catalyst comprising a diameter range of between 1.2 to 3.5 mm.

6. The process of claim 1, wherein the hydrodemetallization catalyst comprises an amorphous support and at least one Group VIB metal selected from molybdenum (Mo) and tungsten (W).

7. The process of claim 1, wherein the feedstock contains a concentration of Vanadium (Va) and Nickel (Ni) ranging from 25 and 500 wtppm.

8. The process of claim 1, wherein the feedstock comprises at least one of a vacuum gas oil (VGO) corresponding to a cut heavier than 370° C. and less than 560° C., de-asphalted oil (DAO) corresponding to a 370+° C. cut after partial removal of asphaltenes through a liquid-liquid extraction process, long or atmospheric residue (LR or AR) corresponding to a 370+° C. cut, and short or vacuum residue (SR or VR) corresponding to a 520+° C. cut.

9. The process of claim 1, wherein the fixed bed reactor comprises at least one residue hydrodesulfurization unit, at least one hydrocracker unit, or a combination thereof.

10. The process of claim 1, wherein at step (a), hydrodemetallization of the feedstock is carried out at a temperature in the range of 300-470° C., at a pressure in the range of from 20-300 bara, at a space velocity of 0.1-10 hr−1, and with a quantity of hydrogen between 200 and 1,500 normal cubic meters per cubic meter of liquid feedstock, wherein the hydrogen is mixed with the feedstock.
